(19) United States
(12) Patent Application Publication
(10) Pub. No.: US 2006/0146843 A1
(43) Pub. Date: Jul. 6, 2006

(54) Device and method for managing automatic setting up of high data rate connections for access from terminals to data networks

(75) Inventors: Madhu-Kumar Krishnan, Antwerpen (BE); Olivier Martinot, Draveil (FR); Guy Mathieu, Orsay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/274,164

(22) Filed: Nov. 16, 2005

(30) Foreign Application Priority Data
Nov. 17, 2004 (FR) 0452654

(51) Int. Cl. H04L 12/56

(52) U.S. Cl. 370/401

(57) ABSTRACT

A device is dedicated to managing the setting up of high data rate connections for access from communication terminals to at least one data network via networks of service providers and a high data rate access equipment connected to at least one high data rate access network managed by a management system and to at least one transport network itself connected to the networks of the service providers, which device comprises analysis means for observing the high data rate connections to the access network and detecting high data rate terminal connection errors and management means for reporting to said management system any high data rate terminal connection error detected and sending it information representing at least one service provider associated with the terminal in order for it to configure the equipment and the associated transport network so that the equipment can access the network of the service provider and send it data received from the terminal representing at least its user and the type of high data rate connection that he is requesting, with a view to setting up the latter connection.

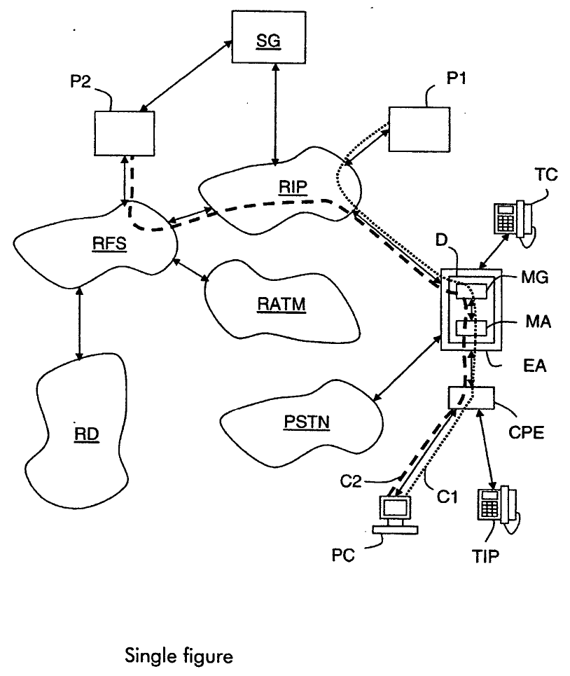

### CROSS-REFERENCE TO RELATED APPLICATIONS

This application is based on French Patent Application No. FR0452654 filed 17/11/04, the disclosure of which is hereby incorporated by reference thereto in its entirety, and the priority of which is hereby claimed under 35 U.S.C. §119.

### BACKGROUND OF THE INVENTION

1. Field of the Invention

The invention relates to communication networks, to be more precise to setting up high data rate connections in such networks.

2. Description of the Prior Art

In the present context the expression “high data rate connection” refers to any type of connection set up between a communication terminal and a data network, for example the Internet, via a physical access provider and a service provider (which may be the same). This connection may therefore be a radio (WiFi or WiMAX) connection, a cable (optical fiber) connection, or a digital subscriber line (xDSL) connection over a balanced or unbalanced pair digital line, using frequencies that are not used by telephone lines of public switched telephone networks (PSTN), and in particular asymmetric DSL (ADSL), high data rate DSL (HDSL), rate adaptive DSL (RDSL), very high data rate DSL (VDSL), and single line DSL (SDSL) connections.

For a communication terminal connected to a telephone network to be able to access a high data rate data network, for example the Internet network, it must use a connection of defined xDSL type on a telephone line (and associated with a telephone number), for example. This relates not only to the terminals of users who are not yet clients of a service provider providing access to a data network but also to the terminals of “nomadic” users who are clients of a service provider and already have an xDSL connection, but on a telephone line other than that to which they wish to connect.

Setting up a high data rate connection, for example of the xDSL type, necessitates many human interventions that may be spread over several days. This is because the user requesting the connection must first contact the service provider it has selected in order to communicate to it at least its identity, the telephone number of the PSTN line that it wishes to use to connect its terminal, and the type of DSL connection that it has selected. A technician must then set up network connections manually on an xDSL access equipment known as a digital subscriber line access multiplexer (DSLAM) of the access network that belongs to or is leased by the physical access provider that manages the telephone line of the user requesting an xDSL connection. A technician must then declare the user requesting an xDSL connection to a management system of the physical access network and to the service provider selected by said user, in order for them to configure the access network and the private network of the service provider. Not knowing the exact time at which the phase of setting up its xDSL connection will occur, the user must therefore test it regularly until it can be used.

An object of the invention is therefore to eliminate this drawback.

### SUMMARY OF THE INVENTION

To this end the invention proposes a device for managing the setting up of high data rate connections for access from communication terminals to at least one data network via networks of service providers and a high data rate access equipment, for example of DSLAM type in the case of an xDSL connection, connected to at least one high data rate (physical) access network managed by a management system and to at least one transport network itself connected to the networks of the service providers, which device comprises analysis means for observing the high data rate connections to said access network and detecting high data rate terminal connection errors and management means for reporting to said management system any high data rate terminal connection error detected and sending it information representing at least one service provider associated with said terminal in order for it to configure said equipment and the associated transport network so that said equipment can access the network of said service provider and send it data received from said terminal representing at least its user and the type of high data rate connection that he is requesting, with a view to setting up the latter connection.

The device of the invention may have other features, and in particular, separately or in combination:

its management means may report a high data rate connection error to the management system in order for it to configure the equipment so that it can access a portal connected to the high data rate access network and send it data received from the terminal and representing the service provider that its user has selected and to send the data representing the service provider to the management system in order for it to perform the configuration of the equipment and of the associated transport network so that the equipment may access the network of the service provider;

if the terminal is being used by a client of a service provider identified by an access code, the management means send the management system information representing the access code for it to determine the service provider corresponding to the access code and to perform the configuration of the equipment and the associated transport network so that the equipment can access the network of the service provider;

its management means may communicate to the equipment data representing a user name and/or a password received from the terminal in order for it to send the data to the network of the service provider for it to determine if the data belongs to a client and to determine the associated high data rate connection type.

The invention also proposes a high data rate access equipment (for example of the DSLAM type in the case of an xDSL connection) for a high data rate access network, comprising a management device of the above kind.

The invention further proposes a method dedicated to setting up high data rate connections, which method consists in monitoring the high data rate connections at the high data rate (physical) access equipment and detecting high data rate connection errors by terminals, reporting to the management system each high data rate connection error by a terminal that has been detected and sending it information representing at least one service provider associated with the terminal, and configuring the equipment and the associated transport network by means of the management system so that the equipment can access the network of the service provider and send it data received from the terminal and representing at least its user and the type of high data rate connection that it is requesting, with a view to setting up the latter connection.

The method of the invention may have other features, and in particular, separately or in combination:

if a service provider decides to authorize the setting up of a high data rate connection by, the network of the service provider may send the authorization to the management system in order for it to configure at least the equipment and the high data rate access network to enable the requested high data rate connection to be set up;

on receiving a high data rate connection error report, the management system may configure the equipment so that it can access a portal of the high data rate access network and send it data received from the terminal and representing the service provider that its user has selected, after which this data representing the service provider is sent to the management system for it to perform the configuration of the equipment and the associated transport network for the equipment to access the network of the service provider;

if a terminal is being used by a client of a service provider identified by an access code, the management system may be sent information representing the access code in order for it to determine the service provider corresponding to the access code and performs the configuration of the equipment and the associated transport network so that the equipment can access the network of the service provider;

the user of the terminal may send the equipment data representing a user name and/or a password in order for it to send the data to the network of the service provider in order for it to determine if the data belongs to a client and the associated high data rate connection type;

the network of the service provider may request the duration of the requested high data rate connection from the terminal;

if the terminal is sending the network of the service provider data representing new high data rate connection characteristics, the management system may adapt the old high data rate connection associated with the user name and/or the password received;

the management system may configure the equipment and the associated transport network so that the equipment can access a portal connected to the network of the service provider and send it the data received from said terminal;

the network of each service provider may generate each authorization to set up a high data rate connection at the level of the portal. The invention is particularly well adapted to xDSL connections, although not in a way that is limiting on the invention. However, it relates equally to other types of high data rate connection, and in particular those effected by radio (for example WiFi or WiMAX connections) or by means of optical fiber cables.

### BRIEF DESCRIPTION OF THE DRAWING

Other features and advantages of the invention will become apparent on reading the following detailed description and examining the appended drawing, the single FIGURE in which is a highly diagrammatic representation of one example of combining communication networks including a management device of the invention. The appended drawing constitutes part of the description of the invention as well as contributing to the definition of the invention, if necessary.

### DETAILED DESCRIPTION OF THE PREFERRED EMBODIMENT

An object of the invention is to enable the automatic setting up of high data rate connections between communication terminals and data networks via access provider networks and service provider networks.

High data rate connections of the xDSL type, for example the ADSL type, are considered hereinafter by way of nonlimiting example, and they therefore use in part telephone lines of a public switched telephone network (PSTN) of a physical access provider. However, the invention applies to other types of high data rate connection, and in particular to those effected by radio (for example WiFi or WiMAX connections) or by optical fiber cables.

As shown in the single FIGURE, in the present context the expression “communication terminal” refers to any communication equipment that can be connected (in the example described) to a telephone line of a public switched telephone network (PSTN), associated with a telephone number. The terminal may therefore be a fixed telephone TS equipped with a modem, an Internet protocol (IP) telephone TIP having an internal modem, a fixed or portable computer PC connected to a modem, or a games console or a television terminal equipped with an internal or external modem.

The telephone lines to which the communication terminals may connect belong to or are leased by one or more physical access providers. In the following description, which is given by way of nonlimiting example, there is only one physical access provider (i.e. the physical connections (copper pair cables) or radio access (WiFi or WiMAX) connections are managed by a single operator) whose network is connected to at least one high data rate access equipment EA directly or via a customer premises equipment (CPE) switch.

In the present example, the access equipment EA is dedicated to xDSL connections and is a digital subscriber line access multiplexer (DSLAM), for example. This type of xDSL access equipment EA is connected to one of the transport networks enabling the various types of communication terminal to set up connections to a data network RD via the private network RF of a service provider and via the physical access network (here the PSTN). For example, the xDSL access equipment EA is connected to an Internet Protocol (IP) network RIP or to an asynchronous transfer mode (ATM) network RATM adapted to transport streams coming from IP telephones TIP and computers PC (or consoles).

Remember that a DSLAM type xDSL access equipment is a concentrator installed at an exchange to implement the xDSL technology and generally consists of modems and filters for concentrating xDSL streams and handling their protocol conversion in order for them to be able to pass from the physical access network to their ATM transport network (RATM) or IP transport network (RIP).

The various transport networks PSTN, RATM and RIP are additionally connected to the “private” networks RFS of service providers enabling access to at least one data network RD, such as the Internet network, for example.

To avoid overcomplicating the single FIGURE, only one service provider private network RFS is shown. However, in reality, many service providers are connected to different transport networks and to different data networks.

As previously indicated, the configuration of the xDSL connections is managed by a management system SG that is generally part of the access network of the physical access provider. To this end the management system SG is connected not only to the xDSL access equipment EA but also to the transport network RATM or RIP to which the xDSL access equipment EA is connected.

Each service provider private network RFS can be managed by its own management system or, as in the present nonlimiting example, by the management system SG of the access provider (for example in the case of the same operator). It is considered hereinafter that the private networks RFS of the various service providers and the access network share the same management system SG.

To enable the automatic setting up of xDSL connections between communication terminals and data networks via access provider and service provider networks, the invention proposes a management device D that is either part of an xDSL access equipment EA or connected thereto.

The management device D comprises an analysis module MA and a management module MG.

The analysis module MA monitors the xDSL connections to the access network to detect xDSL connection errors by the modems of the communication terminals.

In the present context the expression “connection error” refers to any situation preventing the setting up of an xDSL connection, for example failure to configure an xDSL line (or connection), a missing service provider identifier or the impossibility of accessing a service provider.

These errors may occur either if the user does not yet have an xDSL subscription with a service provider or if a “nomadic” or “roaming” user already has an xDSL subscription with a service provider, associated with a first telephone number, and is attempting to set up an xDSL connection with its provider from a telephone line associated with a second telephone number.

In either case, the xDSL connection associated with the telephone number of the line to which the communication terminal is connected is not configured. Consequently, the xDSL access equipment EA is not configured for that xDSL connection either. As the xDSL modem uses a specific frequency to send signals over an xDSL line, the analysis module MA can, by monitoring the signals that reach the xDSL access equipment EA and the reactions thereof, detect that an xDSL modem is attempting to connect to an unconfigured xDSL line associated with a given telephone number, which constitutes an xDSL connection error.

The analysis module MA communicates each xDSL connection error that it detects and the designation of the associated telephone line to the management module MG.

The management module MG signals each xDSL connection error detected to the management system SG and sends it information representing at least a service provider associated with the communication terminal concerned in order for it to configure the xDSL access equipment EA and the associated transport network of that equipment to be able to access the private network RFS of that service provider and send it data received from the communication terminal and representing at least its user and the type of xDSL connection that it is requesting, with a view to setting up the latter connection.

There are at least two ways to send information representing a service provider.

A first way is to have the xDSL modem of the communication terminal that is requesting an xDSL connection (not yet configured) send an identifier representing the access provider that its user has selected, for example an access code. When the management module MG detects the identifier of the access provider, it instructs the xDSL access equipment EA to send it to the management system SG, which is then able to configure it and the associated transport network RATM or RIP, in order for it to be able to access the private network RFS of the selected service provider. Thus a connection can be set up between the modem of the communication terminal (for example the PC) requesting an xDSL connection and the private network RFS of the selected access provider via the xDSL access equipment EA.

A second way is to use a first registration portal P1 to enable the user to communicate the identifier of the access provider it has selected. To this end, each time that the xDSL access equipment EA reports an xDSL connection error to it, the management system SG configures the latter and the associated transport network RATM or RIP in order for the xDSL access equipment EA to be able to access the first portal P1, which preferably belongs to the xDSL access network. Accordingly, as shown in dashed line in the single FIGURE, a first connection C1 can be set up between the modem of the communication terminal (for example the PC) requesting an xDSL connection and the first portal P1 via the xDSL access equipment EA.

Using this first connection C1, the user can then select an access provider and request the xDSL modem of its communication terminal PC to send the xDSL access equipment EA data representing the identifier of the access provider in order for it to send it to the first portal P1. The latter can then communicate the identifier of the selected service provider to the xDSL access equipment EA, which forwards it to the management system SG. Once in possession of this identifier, the management system SG closes the first connection C1 and then configures the xDSL access equipment EA and the associated transport network RATM or RIP in order for the xDSL access equipment EA to be able to access the private network RFS of the selected service provider. Accordingly, as shown in dashed line in the FIGURE, a second connection C2 can be set up between the modem of the communication terminal (for example the PC) requiring an xDSL connection and the private network RFS of the selected service provider via the xDSL access equipment EA.

Once the (second) connection (C2) has been set up between the modem of the communication terminal PC and the private network RFS of the selected service provider, the management module MG of the device D of the invention waits for said private network RFS to communicate authorization to set up an xDSL connection to the xDSL access equipment EA.

That authorization is generated by a second registration portal P2 connected to the private network RFS, for example. This second portal P2 belongs to the selected service provider, for example. In this case, each service provider can have its own portal P2. This is not obligatory, however. It may be envisaged that the various service providers have a common second portal. It may also be envisaged, especially if the physical access provider is also the service provider, that the first portal P1 and the second portal P2 constitute the same centralized portal.

Using this (second) connection (C2), the user can enter information that represents it, for example its identity, its address, the telephone number of the telephone line that it wishes to use for the requested xDSL connection, where applicable its banking details, and the type (or profile) of the xDSL connection that it requires. The user then has the xDSL modem of its communication terminal PC send the xDSL access equipment GA data representing the entered information in order for it to forward it to the (second) portal P2. The person controlling the latter then carries out the usual verifications and, if it accepts the user's xDSL connection request, instructs the (second) portal P2 to generate an authorization to set up an xDSL connection to its management system and to the management system SG of the physical access provider (which here are the same). The management system SG of the physical access provider then sends the configuration instructions to the xDSL access equipment EA and to all the other elements of the networks involved in the connection to be set up. The management system of the service provider (also the management system SG in this case) configures the private network RFS that it manages.

The xDSL access equipment EA, the xDSL access network, the transport network RIP or RATM and the private network RFS of the service provider enabling the physical setting up of the required xDSL connection are therefore configured conjointly.

Once this configuration has been effected, the user can immediately use its xDSL connection to access the data network(s) RD to which the private network RFS of its service provider is connected.

There is described above the situation of a user requesting the setting up of an xDSL connection without being a client of the service provider, or at least without having a subscription in respect of the required xDSL connection. There is described next the situation of a nomadic user who requests setting up of an xDSL connection for which it already has a subscription with a service provider, but for a telephone line other than that which it now wishes to use.

Three situations can arise. In a first situation the telephone line that the user wishes to use is not configured. In a second situation the telephone line that the user wishes to use is configured for a service provider other than the one to which the user wishes to connect. In a third situation the telephone line that the user wishes to use is configured for the service provider to which the user wishes to connect.

In the first and second situations, when the analysis module MA detects in the xDSL access equipment EA the xDSL connection error and the identifier (for example the access code) of the service provider for which the xDSL modem of the communication terminal PC requesting to connect is configured, it instructs the xDSL access equipment EA to send that identifier to the management system SG, which is then able to configure the xDSL access equipment EA and the associated transport network RATM or RIP so that the xDSL access equipment EA can access the private network RFS of the designated service provider. A connection C2 can then be set up between the modem of the communication terminal (for example the PC) requesting an xDSL connection and the private network RFS of the service provider via the xDSL access equipment EA.

As indicated above, this connection C2 may be more specifically set up between the portal P2 of the service provider and the modem of the communication terminal PC via the xDSL access equipment EA.

The user can then enter information that represents it to the service provider, for example its user name (or “login”) and/or its password, as well as the telephone number of the telephone line that it wishes to use for the required xDSL connection. The user then has the xDSL modem of its communication terminal PC send the xDSL access equipment EA data representing the entered information in order for it to send it to the portal P2.

The portal P2 verifies that this data corresponds to a client who has a subscription to an xDSL connection, and if so determines the profile of the xDSL connection of that subscription, for example from a table of correspondences. The portal P2 may prompt the user to modify the profile of the xDSL connection, and in particular its bandwidth. The portal P2 then generates an xDSL connection set-up authorization for its management system and the management system SG of the physical access provider (which in this example are the same). The management system SG of the physical access provider then sends configuration instructions to the xDSL access equipment EA and to all other elements of the networks involved in the connection to be set up. The management system of the service provider (which in this example is also the management system SG) configures the private network RFS that it manages.

Once this configuration has been effected, the user can immediately use its xDSL connection to access the data network(s) RD to which the private network RFS of its service provider is connected.

In the third situation, the xDSL connection being already configured, the user can send directly to the portal P2 of its service provider the information that represents it to the service provider, for example its user name (or “login”) and/or its password, using its communication terminal (for example its PC).

The portal P2 verifies that this data corresponds to a client who has a subscription for an xDSL connection, and if so determines the profile of the connection subscribed to, for example in a table of correspondence. The portal P2 may prompt the user to specify the required duration of the xDSL connection and/or to modify the profile of the xDSL connection, and in particular its bandwidth. If adaptation of the xDSL connection is required, the portal P2 requests it of the management system SG.

Once the verification, and where applicable the adaptation, have been effected, the user can immediately use its xDSL connection to access the data network(s) RD to which the private network RFS of its service provider is connected.

The management device D of the invention, and in particular its management module MG and its analysis module MA, may take the form of electronic circuits, software (or electronic data processing) modules, or a combination of circuits and software.

As indicated above, the device D of the invention may be integrated into the high data rate access equipment, in particular for cost reasons. However, it could equally be installed between the high data rate access equipment and the telephone line.

The invention also provides a method of setting up high data rate connections for access from communication terminals TS, TIP or PC to a data network RD via a network RFS of service providers and a high data rate access equipment EA connected to at least one high data rate access network managed by a management system SG and at least one transport network RATM or RIP, itself connected to the networks of the service providers RFS.

This method can be implemented with the aid of the management device D and the networks described above. The main and optional functions and sub-functions provided by the steps of the method being substantially identical to those provided by the various means constituting the device described above, only the steps implementing the main functions of the method according to the invention are described hereinafter.

The method is characterized in that it consists in monitoring the high data rate connections at the high data rate access equipment EA and detecting high data rate connection errors by terminals, reporting to the management system SG each high data rate connection error by a terminal that has been detected and sending it information representing at least one service provider associated with the terminal, and configuring the equipment EA and the associated transport network RATM or RIP by means of the management system SG so that the equipment EA can access the network RFS of the service provider and send it data received from the terminal and representing at least its user and the type of high data rate connection that it is requesting, with a view to setting up the latter connection.

The invention is not limited to the management device and high data rate access equipment embodiments described above by way of example only and encompasses all variants that the person skilled in the art might envisage that fall within the scope of the following claims.

1. A device for managing the setting up of high data rate connections for access from communication terminals to at least one data network via networks of service providers and a high data rate access equipment connected to at least one high data rate access network managed by a management system and to at least one transport network itself connected to the networks of the service providers, which device comprises analysis means for observing the high data rate connections to said access network and detecting high data rate terminal connection errors and management means for reporting to said management system any high data rate terminal connection error detected and sending it information representing at least one service provider associated with said terminal in order for it to configure said equipment and the associated transport network so that said equipment can access the network of said service provider and send it data received from said terminal representing at least its user and the type of high data rate connection that he is requesting, with a view to setting up the latter connection.

2. The device according to claim 1, wherein said management means report a high data rate connection error to said management system in order for it to configure said equipment so that it can access a portal connected to said high data rate access network and send it data received from said terminal and representing the service provider that its user has selected and to send said data representing the service provider to said management system in order for it to perform said configuration of said equipment and of the associated transport network so that said equipment may access said network of said service provider.

3. The device according to claim 1, wherein, in the presence of a terminal used by a client of a service provider identified by an access code, said management means send said management system information representing said access code for it to determine the service provider corresponding to said access code and to perform said configuration of said equipment and the associated transport network so that said equipment can access said network of said service provider.

4. The device according to claim 3, wherein said management means communicate to said equipment data representing a user name and/or a password received from said terminal in order for it to send said data to said network of said service provider for it to determine if said data belongs to a client and to determine the associated high data rate connection type.

5. A high data rate access equipment for a high data rate access network, comprising a management device according to claim 1.

6. A method for setting up high data rate connections for access from communication terminals to at least one data network via networks of service providers and a high data rate access equipment connected to at least one high data rate access network managed by a management system and to at least one transport network itself connected to the networks of the service providers, which method consists in monitoring the high data rate connections at said high data rate access equipment and detecting high data rate connection errors by terminals, reporting to said management system each high data rate connection error by a terminal that has been detected and sending it information representing at least one service provider associated with said terminal, and configuring said equipment and the associated transport network by means of said management system so that said equipment can access the network of said service provider and send it data received from said terminal and representing at least its user and the type of high data rate connection that it is requesting, with a view to setting up the latter connection.

7. The method according to claim 6, wherein, in the event of a decision to authorize the setting up of a high data rate connection by a service provider, the network of the service provider sends said authorization to said management system in order for it to configure at least said equipment and said high data rate access network to enable the requested high data rate connection to be set up.

8. The method according to claim 6, wherein, on receiving a high data rate connection error report, said management system configures said equipment so that it can access a portal of said high data rate access network and send it data received from said terminal and representing the service provider that its user has selected, after which this data representing the service provider is sent to said management system for it to perform said configuration of said equipment and the associated transport network for said equipment to access said network of said service provider.

9. The method according to claim 6, wherein, in the presence of a terminal used by a client of a service provider identified by an access code, said management system is sent information representing said access code in order for it to determine the service provider corresponding to said access code and performs said configuration of said equipment and the associated transport network so that said equipment can access said network of said service provider.

10. The method according to claim 9, wherein the user of the terminal sends said equipment data representing a user name and/or a password in order for it to send said data to said network of said service provider in order for it to determine if said data belongs to a client and the associated high data rate connection type.

11. The method according to claim 6, wherein the network of the service provider requests the duration of the requested high data rate connection from said terminal.

12. The method according to claim 10, wherein, in the event of said terminal sending said network of the service provider data representing new high data rate connection characteristics, said management system adapts the old high data rate connection associated with the user name and/or the password received.

13. The method according to claim 6, wherein said management system configures said equipment and the associated transport network so that said equipment can access a portal connected to the network of said service provider and send it said data received from said terminal.

14. The method according to claim 13, wherein said network of the service provider generates each authorization to set up a high data rate connection at the level of said portal.
